(19) United States
(12) Patent Application Publication
(10) Pub. No.: US 2024/0023499 A1
(43) Pub. Date: Jan. 25, 2024

(54) RECIPROCATING AQUAPONIC DEVICE

(71) Applicant: National Chung Cheng University, Minsyong Township (TW)

(72) Inventors: Shi-Ming Huang, Minsyong Township (TW); Chih-Yuan Kuo, Minsyong Township (TW); Yi-Feng He, Minsyong Township (TW)

(73) Assignee: National Chung Cheng University, Minsyong Township (TW)

(21) Appl. No.: 18/077,835

(22) Filed: Dec. 8, 2022

(30) Foreign Application Priority Data
Jul. 20, 2022 (TW) 111127253

(51) Int. Cl. A01G 31/02; A01K 63/04; C02F 3/32

(52) U.S. Cl. CPC A01G 31/02; A01K 63/045; C02F 3/327; C02F 2103/20

(57) ABSTRACT

A reciprocating aquaponic device includes a housing, a bell-shaped siphon, and a water pump. The housing defines a water inlet space, and a tidal space and a planting space in fluid communication with the water inlet space. The housing includes a mounting wall over the tidal space, and an inclined wall under the tidal space. The inclined wall is inclined downward toward the planting space. The bell-shaped siphon is dispose on the mounting wall and is disposed for moving water from the water inlet space through the siphon opening and into the tidal space. The water pump is disposed in the fish tank for drawing water from the fish tank into the water inlet space.

### CROSS-REFERENCE TO RELATED APPLICATIONS

This application claims priority of Taiwanese Patent Application No. 111127253, filed on Jul. 20, 2022.

### FIELD

The present disclosure is related to a fish and vegetable symbiotic device, more particularly to a to a reciprocating aquaponic device.

### BACKGROUND

In recent years, organic agriculture using aquaponic organic agriculture has been gradually generating interest. Its approach is to filter and decompose excrement of aquatic animals and organic matter in the water into inorganic salt that is absorbable by the plants, then supply the water to a vegetable on top of a feeding box, where the root of the vegetable further purifies the water in the purification system. The treated water then is reused to supply the aquatic animal and thus make a complete water cycle. The agriculture and hydroponic cultivation are combined to form a mutually symbiotic ecosystem. Therefore, associated techniques of an aquaponic device are constantly under development.

### SUMMARY

Therefore, the object of the disclosure is to provide a reciprocating aquaponic device that can alleviate at least one of the drawbacks associated with the abovementioned prior art.

According to the disclosure, a reciprocating aquaponic device includes a housing, a bell-shaped siphon, a fish tank, and a water pump. The housing defines a water inlet space, a tidal space that is in fluid communication with the water inlet space, and a planting space that is in fluid communication with the tidal space such that water is allowed to flow in a water flowing direction from the water inlet space to the planting space. The housing includes a mounting wall that is disposed adjacent to and over the tidal space, and an inclined wall that is disposed adjacent to and under the tidal space. The mounting wall has a siphon opening that extends vertically therethrough, and that is distal from the planting space. The inclined wall is inclined downward in the water flowing direction toward the planting space. The bell-shaped siphon is dispose on the mounting wall, corresponds in position to the siphon opening, and is disposed for moving water from the water inlet space through the siphon opening and into the tidal space. The fish tank is disposed under the housing. The water pump is disposed in the fish tank for drawing water from the fish tank into the water inlet space.

### BRIEF DESCRIPTION OF THE DRAWINGS

Other features and effects related to the present disclosure will be clearly presented in the embodiments with reference to the drawings, of which:

FIG. 1 is a perspective view of an embodiment of a reciprocating aquaponic device according to the present disclosure with a domesticated plant being implanted thereon;

FIG. 2 is a front view of the embodiment and the domesticated plant;

FIG. 3 is a right side view of the embodiment and the domesticated plant;

FIG. 4 is a schematic right sectional view, illustrating water within a water inlet space having a water level that is higher than the top of an upright tube of a bell-shaped siphon;

FIG. 5 is a view similar to FIG. 4, but illustrating the water within the water inlet space having a water level that is lower than the top of the upright tube and the water is flowing through the bell-shaped siphon by the siphon effect;

FIG. 6 is a view similar to FIG. 5, but illustrating the water within the water inlet space having a water level that is lowered to a state where the siphon effect stops functioning in the bell-shaped siphon; and

FIG. 7 is a view similar to FIG. 2, but illustrating that water flows along an inclined wall through a tidal space.

### DETAILED DESCRIPTION

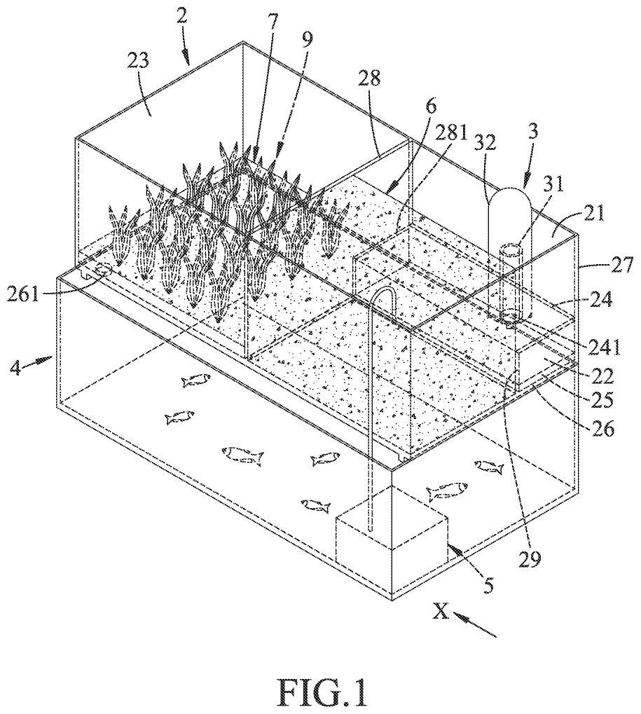

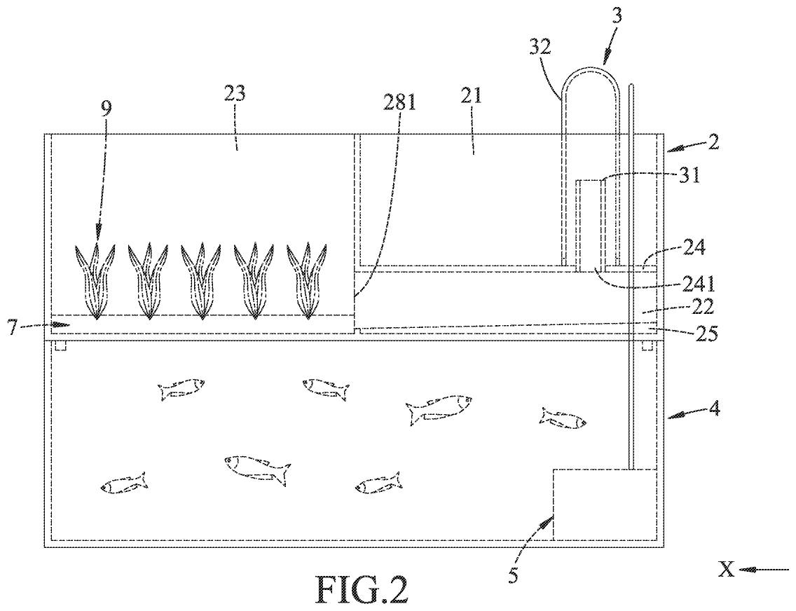

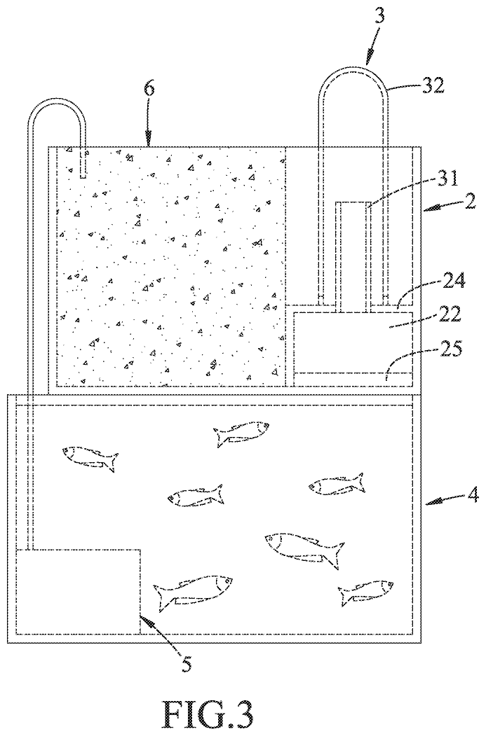

Referring to FIGS. 1, 2 and 3, an embodiment of an aquaponic device according to this disclosure is adapted for implant of a domesticated plant 9 thereon, and the reciprocating aquaponic device includes a housing 2, a bell-shaped siphon 3, a fish tank 4, a water pump 5, a water inlet filtering material 6, and a water drain filtering material 7.

The housing 2 defines a water inlet space 21, a tidal space 22 being in fluid communication with the water inlet space 21, and a planting space 23 being in fluid communication with the tidal space 22 such that water is allowed to flow in a water flowing direction (X) from the water inlet space 21 to the planting space 23. The planting space 23 is used for planting the implant plant 9.

The housing 2 includes a mounting wall 24 disposed adjacent to and over the tidal space 22, an inclined wall 25 disposed adjacent to and under the tidal space 22, a bottom wall 26 disposed under and connected to the inclined wall 25, a surrounding wall 27 extending upward from an outer periphery of the bottom wall 26 to define the water inlet space 21, the tidal space 22, and the planting space 23, and surrounding the bell-shaped siphon 3, a first partition wall 28 connected between the bottom wall 26 and the surrounding wall 27 to partition the water inlet space 21 and the planting space 23 in the water flowing direction (X), and a second partition wall 29 connected to the mounting wall 24, the inclined wall 25, the first partition wall 28, and the surrounding wall 27 to partition the water inlet space 21 and the tidal space 22.

The mounting wall 24 has a siphon opening 241 that extends vertically therethrough and that is distal from the planting space 23. The inclined wall 25 is inclined downward in the water flowing direction (X) toward the planting space 23. The bottom wall 26 has a drainage hole 261 extending vertically therethrough and interconnecting the planting space 23 and the fish tank 4. The first partition wall 28 has a tide through hole 281 interconnecting the tidal space 22 and the planting space 23, and corresponding in position to the inclined wall 25, for water flowing in the water flowing direction (X) to go through. In this embodiment, the inclined wall 25 is inclined downward in the water flowing direction (X) toward the planting space 23 by an angle ranging from 3 to 5 degrees.

The bell-shaped siphon 3 is disposed on the mounting wall 24, corresponding in position to the siphon opening 241, and is used for moving water from the water inlet space 21 through the siphon opening 241 and into the tidal space 22. The bell-shaped siphon 3 includes an upright tube 31 that is disposed on the mounting wall 24, that extends upward, and that is connected to the siphon opening 241, and a bell-shaped cover 32 that covers from a top of and around the upright tube 31. The bell-shaped cover 32 has openings at the bottom to allow water going into the bell-shaped siphon 3 to produce siphon effect around the upright tube 31.

The fish tank 4 is disposed under the housing 2 and is used for culturing fish.

The water pump 5 is disposed in the fish tank 4, and is used to draw water from the fish tank 4 into the water inlet space 21.

The water inlet filtering material 6 is disposed in the water inlet space 21, and the water inlet filtering material 6 serves to filter water drawn into the water inlet space 21 by the water pump 5.

In this embodiment, the water inlet filtering material 6 is bamboo charcoal or bamboo charcoal cotton that has a biochemical filtering effect to convert ammonia into nitric acid.

The water drain filtering material 7 is disposed in the planting space 23 and is used for filtering the water flowing out of the drainage hole 261 from the planting space 23. The water drain filtering material 7 is adapted for implant of the domesticated plant 9 thereon, thereby keeping a preset distance between the implant plant 9 and the bottom wall 26.

In this embodiment, the water drain filtering material 7 is bamboo charcoal that has the additional effect of trapping organic material.

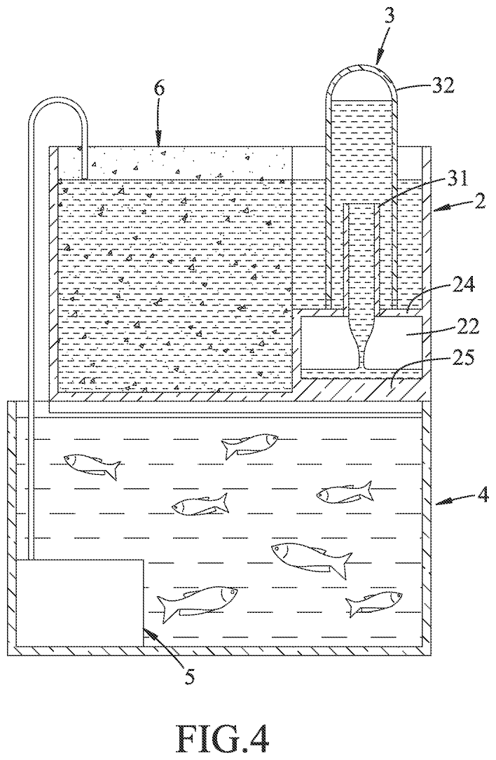

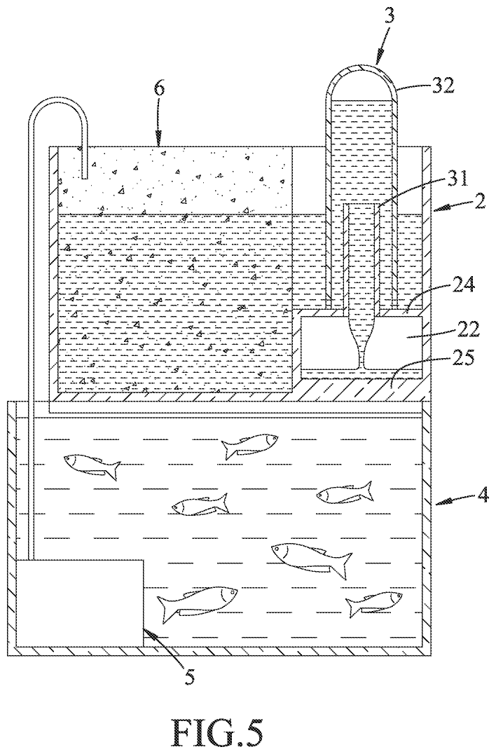

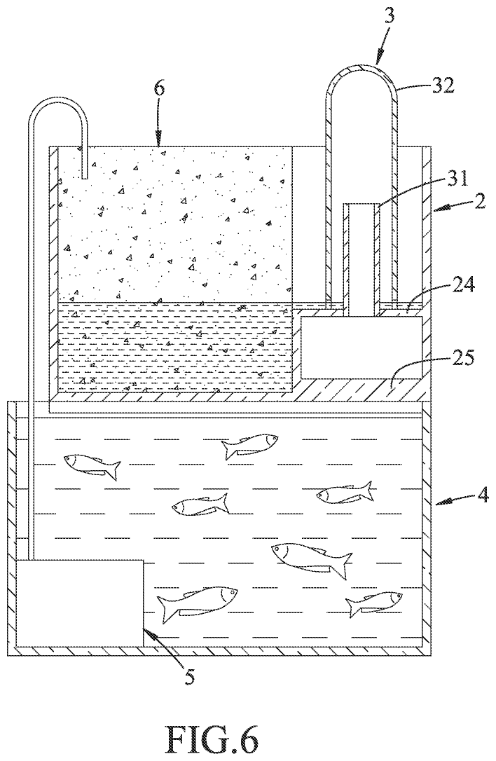

Referring to FIGS. 1 and 4, when this device is in use, water with excrement (i.e., ammonia) is drawn by the water pump 5 to flow into the water inlet space 21 through the water inlet filtering material 6 with the excrement being filtered by the water inlet filtering material 6. When the water level of the water accumulating in the water inlet space 21 is higher than the top of the upright tube 31 (see FIG. 4), the bell-shaped siphon 3 moves the water through the siphon opening 241 into the tidal space 22 with the siphon effect. At this time, referring to FIGS. 1, 5, and 6, the water pump 5 is temporarily shut off and no longer drawing water to the water inlet space 21, and the bell-shaped siphon 3 will continue to move water into the siphon opening 241 (see FIG. 5) until the water level in the water inlet space 21 is lower than the bottom boundary of the bell shaped cover 32. Then the water flow stops (see FIG. 6).

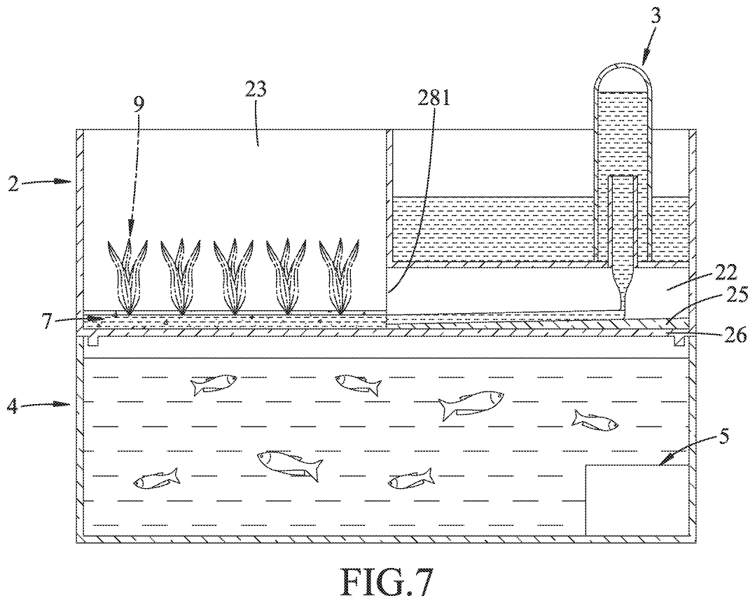

Referring to FIGS. 1 and 7, the water advanced into the tidal space 22 flows downward along the inclined wall 25 and through the tide through hole 281 into the planting space 23, and gradually raises the water level in the planting space 23 to be higher than the water drain filtering material 7 to reach the root of the implant plant 9. On the other hand, the ammonia contained in the water is converted by nitrifying bacteria into nitrates. Therefore, the root of the domesticated plant 9 can absorb the water (with the nitrates) and at the same time purify the water. Then, the purified water discharges from the drain filtering material 7 through the draining hole 261 to the fish tank 4, so that the root of the domesticated plant 9 is no longer submerged in water to avoid being rotted from drowning. Through the abovementioned procedures, a complete water cycle for the aquaponic system is accomplished. The water pump 5 is then turned on and off periodically to continuously repeat the aforementioned water cycling procedure for the aquaponic system.

By the siphon effect of the bell-shaped siphon 3, water within the tidal space 22 can go up and down like the tide, thus achieving a tidal effect. This tidal effect cooperates with the slope of the inclined wall 25 to generate an effect like the tidal impact at a shore when the water flows, thereby distributing the water evenly in the water drain filtering material 7 and allowing the roots of the domesticated plant 9 to absorb the nitrates better.

In summary, by disposing the bell-shaped siphon 3 and the inclined wall 25, tides can be generated to create the rising and falling effect on the water, as well as the effect of the tide's impact on the shore, so that the domesticated plant 9 can absorb the nitrates in the water better to promote growth, thereby practically achieving the objectives of the present disclosure.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A reciprocating aquaponic device comprising:
a housing defining a water inlet space, a tidal space that is in fluid communication with said water inlet space, and a planting space that is in fluid communication with said tidal space such that water is allowed to flow in a water flowing direction from said water inlet space to said planting space,
said housing including a mounting wall that is disposed adjacent to and over said tidal space, and an inclined wall that is disposed adjacent to and under said tidal space,
said mounting wall having a siphon opening that extends vertically therethrough, and that is distal from said planting space,
said inclined wall being inclined downward in said water flowing direction toward said planting space;
a bell-shaped siphon disposed on said mounting wall, corresponding in position to said siphon opening, and disposed for moving water from said water inlet space through said siphon opening and into said tidal space;
a fish tank disposed under said housing; and
a water pump disposed in said fish tank for drawing water from said fish tank into said water inlet space.

2. The reciprocating aquaponic device as claimed in claim 1, wherein said housing further includes a bottom wall disposed under and connected to said inclined wall, and a surrounding wall extending upward from an outer periphery of said bottom wall, defining said water inlet space, said tidal space and said planting space, and surrounding said bell-shaped siphon, said bottom wall having a drainage hole that extends vertically therethrough and that interconnecting said planting space and said fish tank.

3. The reciprocating aquaponic device as claimed in claim 2, wherein said housing further includes a first partition wall connected between said bottom wall and said surrounding wall and partitioning said water inlet space and said planting space in said water flowing direction, and a second partition wall connected to said mounting wall, said inclined wall, said first partition wall, and said surrounding wall and cooperating with said mounting wall to partition said water inlet space and said tidal space, said first partition wall having a tide through hole that interconnects said tidal space and said planting space and that corresponds in position to said inclined wall.

4. The reciprocating aquaponic device as claimed in claim 2, further comprising a water inlet filtering material disposed in said water inlet space, said water inlet filtering material being disposed for filtering the water drawn into said water inlet space by said water pump.

5. The reciprocating aquaponic device as claimed in claim 2, further comprising a water drain filtering material disposed in said planting space, said water drain filtering material being disposed for filtering water flowing from said planting space out of said drainage hole, said water drain filtering material being adapted for implant of a domesticated plant thereon, thereby keeping a preset distance between said implant plant and said bottom wall.

6. The reciprocating aquaponic device as claimed in claim 2, wherein said inclined wall is inclined downward in the water flowing direction toward the planting space by an angle ranging from 3 to 5 degrees.

7. The reciprocating aquaponic device as claimed in claim 2, wherein said bell-shaped siphon includes an upright tube disposed on said mounting wall, extending upward, and connected to said siphon opening, and a bell-shaped cover covering from a top of and around said upright tube.
